(19) United States
(12) Patent Application Publication
(10) Pub. No.: US 2024/0122194 A1
(43) Pub. Date: Apr. 18, 2024

(54) PLANT-BASED YOGURT PRODUCT

(71) Applicant: DSM IP Assets B.V., HEERLEN (NL)

(72) Inventors: Pieter Cornelis LANGEVELD, ECHT (NL); Johanna Corline Margriet VINK, ECHT (NL); Arjen SEIN, ECHT (NL)

(21) Appl. No.: 18/546,788

(22) PCT Filed: Feb. 23, 2022
(86) PCT No.: PCT/EP2022/054476

§ 371 Date: Aug. 17, 2023

(30) Foreign Application Priority Data
Feb. 23, 2021 (EP) 21158581.5
Mar. 16, 2021 (EP) 21162984.5
Oct. 14, 2021 (EP) 21202734.6

(51) Int. Cl. A23C 11/10; A23J 3/14

(52) U.S. Cl. CPC A23C 11/106; A23J 3/14

(57) ABSTRACT

The present invention relates to a plant-based yogurt comprising rapeseed protein and pea protein in a total amount of 1 to 10% (w/w) of the plant-based yogurt, wherein the weight ratio of rapeseed protein to pea protein is from 80:20 to 5:95, preferably is from 60:40 to 5:95.

### FIELD OF THE INVENTION

The present invention is directed to a plant-based yogurt. Further the present invention relates to a method for manufacturing a plant-based yogurt. Further the present invention relates to the use of rapeseed protein.

### BACKGROUND OF THE INVENTION

Food products comprising plant proteins as alternative to animal-derived proteins nowadays receive attention because of consumer concerns about the environmental impact of animal-based products and the beneficial nutritional characteristics of plant-based foods. In particular, products based on plant proteins as alternative to dairy products such as milk and yogurt have gained popularity. Plant proteins may be derived from a variety of plant sources, like legumes and pulses such as soybean, pea, chickpea, fava bean, lentil, mung bean, peanut, lupin; oil seeds/cabbages such as rapeseed or canola, sunflower, camelina, sesame; cereals and pseudo cereals, such as wheat, barley, oat, rice, sorghum, quinoa, buckwheat; nuts, such as, hazelnut, walnut, cashew; coconut; nightshades such as potato.

Unfortunately, in plant-based dairy products, such as plant-based yogurt, plant proteins are perceived as astringent and bitter, generally being an unwanted sensory attribute. Especially in fermented products like yogurt (analogues) with a low pH, astringency often becomes too overbearing and is difficult to mask. Furthermore, addition of plant proteins into dairy-like products (such as plant-based yogurt), can lead to physio-chemical instability issues such as protein sedimentation or precipitation of food particles. The problem may occur already just after mixing the ingredients. Sedimentation makes it difficult to get a homogeneous solution/dispersion in the remainder of the process. Problem worsens upon heat treatment required to obtain microbiologically stable products or after acidification.

WO2020/254504 relates to emulsion-type compositions comprising rapeseed protein, and the instability and astringency thereof. It was found that the instability associated with the production of emulsion-based beverages comprising rapeseed protein can be overcome by addition of hydrocolloids, optionally in combination with sufficient shear. It was reported that astringency of highly aqueous liquid products containing plant protein was reduced.

WO2020/104192 relates to a method of making a beverage, and to high-protein, shelf-stable and clear appearance beverages at neutral pH conditions by means of extensive hydrolysis of the protein by proteases. The use of acids was avoided due to resulting problem of astringency.

WO2019/238371 discloses a process for improving the sensory quality of a composition which contains plant proteins, comprising bringing the plant protein, such as pea-protein containing composition in contact with a food grade oily composition, and removing the oily phase from the plant protein composition. Reported was that the process resulted in a reduction in bitterness and astringency.

WO2019/115280 relates to beverages products based on plant proteins with improved texture and mouthfeel. The disclosed method comprises an ultra-high temperature (UHT) heat treatment to form agglomerated proteins and shearing to reduce the size of the agglomerated proteins. It was reported that performing heat treatment in combination with shearing it was possible to avoid losing the viscosifying and creaminess attributes in the product having a pH 5.3 to 6.7.

WO2014190418 relates to the production of pulse protein products with reduced astringency. It is reported that undesirable astringency can be reduced or eliminated by modifying the procedure used to manufacture the pulse protein product. The process was modified to remove proteins which precipitate at a pH of about 5 to about 6.5 and that may interact with salivary proteins, thereby producing a less astringent product. Removal of proteins is not desired from a sustainability point of view.

WO2020243081 relates to plant-based yogurt products having a high protein content without the unpleasant taste associated with high protein from a plant-based source. It was reported that nut butters, and in particular, macadamia nut butter, can be added to a plant-based yogurt composition to mask the unpleasant taste associated with plant proteins. The disadvantage of adding nut butter is that it is an allergenic composition.

In view of the conventional techniques, there is a need for plant-based yogurts having an improved mouthfeel and texture, and a reduction of astringent taste.

### DESCRIPTION

The above problem, amongst other problems, is solved by the present invention by providing a plant-based yogurt according to the appended claims.

More specifically, the above problem, amongst other problems, is solved by providing a plant-based yogurt comprising rapeseed protein and pea protein in a total amount of 1 to 10% (w/w) of the plant-based yogurt, wherein the weight ratio of rapeseed protein to pea protein is from 80:20 to 5:95, preferably is from 60:40 to 5:95.

Surprisingly, the present inventors found that by the combination of pea protein and rapeseed protein, the astringency of the plant-based yogurt is reduced, and the stability of the yogurt is improved.

The term ‘plant-based yogurt’ as used in the present context means an acidified or fermented plant milk product. The plant-based yogurt is free from animal protein, like free from dairy milk protein, and thus can also be qualified as a ‘yogurt analogue’, ‘yogurt equivalent’, ‘yogurt substitute’, or ‘yogurt replacer’. The plant-based yogurt has an appearance comparable to dairy milk protein-based yogurt. For example, the plant-based yogurt has a white colour, taste, texture, viscosity, mouthfeel and/or flowing behaviour that is substantially similar to dairy milk protein-based yogurt.

The term ‘plant milk’ is a dispersion or emulsion comprising plant protein and optionally other plant matter, optionally stabilized by hydrocolloids (from plant or microbial origin) and a mineral source such as for instance calcium phosphate.

The term ‘rapeseed protein and pea protein in a total amount of 1 to 10% (w/w) of the plant-based yogurt’ as used in the present context means that the sum of the amount of rapeseed protein and pea protein is within 1 to 10% (w/w) of the plant-based yogurt.

Preferably, the present plant-based yogurt comprises rapeseed protein and pea protein in a total amount of 1 to 9% (w/w), 1.5 to 8% (w/w), 1.6 to 7% (w/w), 2 to 6% (w/w) or 2.5 to 5% (w/w) of the plant-based yogurt. Alternatively, the present weight ratio of rapeseed protein to pea protein is from 50:50 to 80:20, such as from 60:40 to 75:25.

In an embodiment, the rapeseed protein and pea protein are isolates. Preferably, the present plant-based yogurt comprises rapeseed protein isolate and pea protein isolate in a total amount of 1 to 10% (w/w), 1 to 9% (w/w), 1.5 to 8% (w/w), 1.6 to 7% (w/w), 2 to 6% (w/w) or 2.5 to 5% (w/w) of the plant-based yogurt. Preferably the rapeseed protein and pea protein are isolates comprise a protein content of at least 85% (w/w), at least 90% (w/w) or at least 95% (w/w) of the rapeseed and pea protein isolates.

In an embodiment, the present weight ratio of rapeseed protein to pea protein is from 80:20 to 20:80, preferably is from 60:40 to 20:80.

Preferably, the present weight ratio of rapeseed protein to pea protein is from 80:20 to 5:95, preferably from 75:25 to 5:95, preferably from 70:30 to 5:95, preferably from 65:35 to 5:95, preferably is from 60:40 to 5:95, preferably is from 55:45 to 5:95, preferably is from 50:50 to 10:90, preferably is from 50:50 to 15:85, preferably is from 50:50 to 20:80.

Preferably, the present weight ratio of rapeseed protein to pea protein is from 80:20 to 10:90, preferably from 70:30 to 10:90, preferably from 75:30 to 10:90, preferably from 65:35 to 10:90, preferably is from 60:40 to 10:90, preferably is from 55:45 to 10:90.

Preferably, the present weight ratio of rapeseed protein to pea protein is from 80:20 to 15:85, preferably from 70:30 to 15:85, preferably from 75:30 to 15:85, preferably from 65:35 to 15:85, preferably is from 60:40 to 15:85, preferably is from 55:45 to 15:85.

Preferably, the present weight ratio of rapeseed protein to pea protein is from 75:25 to 25:75, preferably from 70:30 to 30:70, preferably from 60:40 to 40:60, preferably from 55:45 to 45:55, preferably 50:50. Alternatively, the present weight ratio of rapeseed protein to pea protein is from 50:50 to 80:20, such as from 60:40 to 75:25.

In an embodiment, the present plant-based yogurt has a pH within the range of 3.0 to 6.0, preferably 3.5 to 5.0, preferably 3.8-4.6. More preferably, the present plant-based yogurt has a pH within the range of 4.2 to 4.9, such as of 4.3 to 4.8 or 4.4 to 4.7. The advantage of providing an acidified plant-based yogurt is that the product mimics the appearance and taste of dairy milk-based yogurt. Further, it preserves the plant-based yogurt as the acidic pH range reduces growth of microorganisms.

Preferably, the present plant-based yogurt comprises lactic acid, citric acid, malic acid, gluconic acid or glucono delta-lactone, or phosphoric acid, or combinations thereof.

In an embodiment, the present plant-based yogurt further comprises lactic acid bacteria, or a combination of lactic acid bacteria and an acid. In other words, preferably, the present plant-based yogurt is a fermented plant milk product, or a fermented plant-based yogurt. Preferably, the plant-based yogurt comprises at least 10⁶, preferably at least 10⁷, preferably at least 10⁸ CFU or at least 10⁹ CFU (colony-forming unit) per gram of the plant-based yogurt.

As used herein, the term “lactic acid bacteria” (LAB) or “lactic bacteria” refers to food-grade bacteria producing lactic acid as the major metabolic end-product of carbohydrate fermentation. These bacteria are related by their common metabolic and physiological characteristics and are usually Gram positive, low-GC, acid tolerant, non-sporulating, non-respiring, rod-shaped bacilli or cocci. During the fermentation stage, the consumption of sucrose or lactose by these bacteria causes the formation of lactic acid, reduces the pH and leads to the formation of a protein coagulum. These bacteria are thus responsible for the acidification of plant milk and for the texture of the fermented plant milk product. As used herein, the term “lactic acid bacteria” or “lactic bacteria” encompasses, but is not limited to, bacteria belonging to the genus of Lactobacillus spp., Bifidobacterium spp., Streptococcus spp., Lactococcus spp., such as Lactobacillus delbruekii subsp. bulgaricus, Streptococcus themiophilus, Lactobacillus lactis, Bifidobacterium animalis, Lactococcus lactis, Lactobacillus casei, Lactobacillus plantarum, Lactobacillus helveticus, Lactobacillus acidophilus and Bifidobacterium breve. Preferably, the present plant-based yogurt comprises Lactobacillus delbruekii subsp. bulgaricus and Streptococcus themiophilus.

Acidification may also be carried out by a combination of adding acid and adding lactic acid bacteria. For example, the acid can be added after fermentation of lactic acid bacteria to further tune the pH, or before the fermentation. In a further embodiment an acidity regulator can be used, which is usually a buffering system such as a mixture of sodium citrate and citric acid.

The present plant-based yogurt can be provided in several beneficial yogurt forms. Therefore, in an embodiment, the present plant-based yogurt is set yogurt, stirred yogurt, drinking yogurt, Petit Suisse, Greek-style yogurt, skyr-style, heat-treated yogurt or a yogurt-like products (such as kefir, lassi, dahi, ymer). Preferably, the present plant-based yogurt is drink yogurt, stirred yogurt or set yogurt. Preferably the plant-based yogurt is pourable or spoonable.

The rapeseed used to obtain the rapeseed protein (isolate) as applied in the instant invention is usually of the varieties Brassica napus or Brassica rapa. These varieties contain low levels of erucic acid and glucosinolates, and are the source of canola, a generic term for rapeseed oil comprising less than 2% erucic acid and less than 30 mmol/g glucosinolates. The predominant storage proteins found in rapeseed are cruciferins and napins. Cruciferins are globulins and are the major storage protein in the seed. A cruciferin is composed of 6 subunits and has a total molecular weight of approximately 300 kDa. Napins are albumins and are low molecular weight storage proteins with a molecular weight of approximately 14 kDa. Napins are more easily solubilized and are primarily proposed for use in applications where solubility is key. Rapeseed proteins can also be divided into various fractions according to the corresponding sedimentation coefficient in Svedberg units (S). This coefficient indicates the speed of sedimentation of a macromolecule in a centrifugal field. For rapeseed proteins, the main reported fractions are 12S, 7S and 2S. Napin is a 2S albumin, and cruciferin is a 12S globulin.

In an embodiment, the present rapeseed protein (isolate) comprises cruciferins and/or napins, preferably comprising 10 to 95% (w/w) cruciferins and/or 5% to 90%% (w/w) napins (of the rapeseed protein or of the rapeseed protein isolate). The sum of the napins and cruciferins is not exceeding 100%.

The advantage of using a rapeseed protein comprising substantially or completely napins is that napins provide a good solubility and may provide a sweet taste. On the other hand, the advantage of using rapeseed protein comprising substantially or completely cruciferins is that cruciferins provide texture to the plant-based milk product. Advantageously, combinations of napin fractions and cruciferin fractions can be made to provide the desired characteristics of a plant-based yogurt. Hence, for a drink yogurt the amounts of napins can be larger, whereas for a set or Greek yogurt the amount cruciferins can be larger.

Preferably, the rapeseed protein (isolate) comprises from 15 to 65% (w/w) cruciferins and from to 85% (w/w) napins, the total being equal to or less than 100%, and preferably has a solubility of at least 88% or at least 94%, when measured over a pH range from 3 to 10 at a temperature of 23±2° C. In the context of the present invention, the rapeseed protein (isolate) comprises cruciferins and napins, preferably from 15 to 65% (w/w) cruciferins and from 35 to 85% (w/w) napins, the total being equal to or less than 100%.

In one embodiment the present rapeseed protein (isolate) comprises 40-65% (w/w) cruciferins and 35-60% (w/w) napins, preferably wherein the sum of cruciferins and napins is not exceeding 100% (w/w). The inventors found that the indicated combination of cruciferins and napins is able to provide stable, white and less astringent plant-based yogurt.

In a preferred embodiment, the present rapeseed protein (isolate) comprises 60 to 80% (w/w) cruciferins and 20 to 40% (w/w) napins. Preferably, the present rapeseed protein (isolate) comprises 65 to 75% (w/w) cruciferins and 25 to 35% (w/w) napins.

In a preferred embodiment, the present rapeseed protein (isolate) comprises 0 to 10% (w/w) cruciferins and 90 to 100% (w/w) napins. Preferably, the present rapeseed protein (isolate) comprises 1 to 5% (w/w) cruciferins and 95 to 100% (w/w) napins.

Preferably, the amounts of cruciferins and napins is calculated based on the total amount of protein in the present plant-based yogurt. Or alternatively, the amounts of cruciferins and napins are calculated based on the sum of cruciferins and napins present in the plant-based yogurt. Preferably, the amounts of cruciferins and napins are determined by size exclusion chromatography (SEC). Preferably, the amounts of cruciferins and napins are determined by size exclusion chromatography (SEC) using the following test:
samples of protein isolate are dissolved in a 500 mM NaCl saline solution and analyzed by High Performance SEC using the same solution as the mobile phase, followed by detection using measuring UV absorbance at 280 nm, wherein the relative contribution of cruciferin and napin (wt. %) was calculated as the ratio of the peak area of each protein with respect to the sum of both peak areas.

Preferably, the present rapeseed protein (isolate) comprises 40 to 65 wt. % 12S and 35 to 60 wt. % 2S. Preferably, the present rapeseed protein (isolate) comprises 40 to 55 wt. % 12S and 45 to 60 wt. % 2S.

In a preferred embodiment, the present rapeseed protein (isolate) comprises 60 to 80 wt. % 12S and 20 to 40 wt. % 2S. Preferably, the present rapeseed protein (isolate) comprises 65 to 75 wt. % 12S and 25 to 35 wt. % 2S.

In a preferred embodiment, the present rapeseed protein (isolate) comprises 0 to 10 wt. % 12S and 90 to 100 wt. % 2S. Preferably, the present rapeseed protein (isolate) comprises 1 to 5 wt. % 12S and 95 to 100 wt. % 2S.

Preferably, the amounts of 12S and 2S is determined by sedimentation velocity analytical ultracentrifugation (SV-AUC) analysis. Preferably, the amounts of 12S and 2S is determined by sedimentation velocity analytical ultracentrifugation (SV-AUC) analysis using the following test:
samples of protein isolate are dissolved in a 3.0% (or 500 mM) NaCl saline solution and amounts determined using interference optics.

In an embodiment, the present rapeseed protein (isolate) does not comprise gluten or gliadin, i.e. the present rapeseed protein is so called gluten free. By gluten free is meant that the composition comprises less than 20 ppm of gluten and more preferably less than 10 ppm of gluten. Gluten is usually measured by measuring the gliadin content, for example as described in WO 2017/102535. Therefore, according to the present invention there is provided a gluten free composition comprising less than ppm gliadin.

In an embodiment, the present rapeseed protein has an enthalpy of denaturation in the hydrated state (DH value) of around 0, for example of from 0 to 1 J/g or of 0±0.5 J/g. The DH value may be established for example by measuring a 40% (w/w) solution or dispersion of rapeseed protein isolate in water by means of Differential Scanning calorimetry (DSC). This enthalpy of denaturation can be the result of the pasteurization step. Native rapeseed protein isolate usually has an enthalpy of denaturation in the hydrated state of from 1 to 10 J/g, or of from 2 to 6 J/g of a 40% (w/w) protein solution.

In an embodiment the rapeseed protein (isolate) has a DIAAS value in older children, adolescents and adults aged 3 yr. and older which is equal to or higher than 100. In an embodiment the DIAAS value is from 100 to 200, or from 105 to 150, or from 110 to 135. For example, the DIAAS value may be 110±10.

In the context of the present invention the term “DIAAS” refers to Digestible Indispensable Amino Acid Score and is calculated as recommended by the Food and Agriculture Organization of the United Nations (Report of an Expert Consultation (2013) of the Food and Agriculture Organization of the United Nations (FAO); Dietary Protein Quality Evaluation in Human Nutrition) using equation DIAAS (%)=100×lowest value of the DIAA reference ratio. The DIAAS values may be calculated for different age groups and in the context of the present invention this is done according to the above FAO recommendation for 3 different age groups. These are infants (from birth to 6 mo.), children (from 6 mo. to 3 yr.), and older children, adolescents and adults (≥3 yr.).

The term “DIAA reference ratio” refers to Digestible Indispensable Amino Acid reference ratio and is calculated according to Cervantes-Pahm et al. (Br. J. Nutr. (2014) 111:1663-1672) using equation DIAA reference ratio=digestible indispensable amino acid content in 1 g protein of food (mg)/mg of the same dietary indispensable amino acid in 1 g of the reference protein.

In an embodiment, the present rapeseed protein (isolate) has a DIAAS value, preferably a DIAAS value in older children, adolescents and adults aged 3 yr. and older, which is equal to or higher than 100. In an embodiment the DIAAS value is from 100 to 200, or from 105 to 150, or from 110 to 135. For example, the DIAAS value may be 110±10. Preferably, the DIAAS value is from 101 to 130, or from 102 to 125, or from 103 to 120, or from 103 to 115.

It was found that heat-treated rapeseed protein has superior DIAAS values compared to other plant-derived proteins. As is shown in the experimental part, pasteurization temperatures might denature the protein and increase the DIAAS value. This is advantageous for the plant-based yogurt according to the present invention, as they have a beneficial nutritional value.

Therefore, in a preferred embodiment, the present invention relates to a plant-based yogurt comprising rapeseed protein, a vegetable oil, starch and water, wherein the rapeseed protein has a DIAAS value of which is equal to or higher than 100. In an embodiment the DIAAS value is from 100 to 200, or from 105 to 150, or from 110 to 135. For example, the DIAAS value may be 110±10. Preferably, the DIAAS value is from 101 to 130, or from 102 to 125, or from 103 to 120, or from 103 to 115.

In another embodiment the present plant-based yogurt does not comprise soy-derived protein or fava bean protein. In still another embodiment the composition does not comprise gluten or gliadin and does not comprise soy-derived protein. Both gluten and soy are allergenic, and thus it is advantageous that the present invention provides plant-based yogurt without inclusion of allergenic ingredients.

The present pea protein is preferably a pea protein isolate. For example, a pea protein isolate having at least 85% (w/w) or at least 90% (w/w) on dry matter content protein. Alternatively, the present pea protein comes from a pea protein concentrate, for example as obtained by dry fractionation or air classification, and may contain 50-65% protein (w/w) on dry matter.

In addition to the present rapeseed protein and pea protein, the present plant-based yogurt may comprise another plant-based protein, such as proteins from legumes and pulses such as, fava bean protein, chickpea protein, lupin protein, lentil protein, mung bean protein, peanut; or seed proteins such as cotton seed protein, sunflower seed protein, sesame seed protein, camelina; cereal or pseudo cereal protein, such as oat protein, rice protein, corn protein, sorghum protein, quinoa protein, buckwheat; leaf protein such as alfalfa protein, clover protein, duckweed protein, grass protein; protein from stem or root tuber protein such as potato protein, sweet potato protein, cassava protein, yam protein, taro protein; protein derived from nuts, such as almond, hazelnut, walnut, cashew; coconut protein, or proteins from algal, insect or microbial sources, or proteins produced via fermentation (i.e. precision fermentation) such as fermentative dairy milk protein or fermentative egg protein.

In another embodiment, the plant-based yogurt may comprise plant matter from legumes other than the proteins such as fibers. Preferably a plant matter from pulse. Preferably the pulse is selected from the group consisting of split peas, field peas, dry peas, lentil, chickpeas, pea bean, cow pea, roman bean, green bean, mung bean, lima bean, Madagascar bean, horse bean, pinot bean, small red bean, red Mexican bean, mottled bean, speckled sugar bean, faba bean, lima bean, garbanzo bean, kidney bean, black turtle bean, cranberry bean, green gram, green bean, black gram, urad dal, soy and/or lupin.

In an embodiment, the present plant-based yogurt comprises starch. Preferably, the total amount of starch (single ingredient or mixture of more than one) is from 0.5-20% (w/w), from 1.0 to 20% or from 2.0-10% (w/w), or from 3.0-8% (w/w) of the plant-based yogurt. Starch for use in the present invention can be native, non-modified or modified starch (degraded, enzymatically modified, or stabilized, chemically or physically modified), or mixtures thereof. Preferably the starch is tapioca starch.

In an embodiment, the present plant-based yogurt further comprises a vegetable oil or fat and optionally an emulsifier. Preferably, the amount of vegetable oil or fat is from 0.5 to 20% (w/w), from 1-20% (w/w), from 2 to 10% (w/w), from 3 to 8% (w/w) or from 2.5 to 5.0% (w/w) of the plant-based yogurt.

Preferably, the present vegetable oil or fat is liquid at 5° C., or the vegetable oil is solid at 5° C., or combinations thereof. Hence, the vegetable oil can be a combination of oil that is liquid at 5° C. with a vegetable oil that is solid at 5° C.

In an embodiment, the vegetable oil comprises a vegetable oil having a solid fat content of 0-90% (w/w) 5-80% (w/w), preferably 10-70% (w/w), or 20-50% (w/w) at 5° C. Preferably, the present vegetable oil comprises more than 90% (w/w) triglycerides.

In the context of the invention, suitable vegetable oils or fats are corn oil, olive oil, rapeseed oil or canola oil, soya bean oil, sunflower oil, high oleic sunflower oil, camelina oil, groundnut oil, cotton seed oil, safflower oil, sesame oil, rice bran oil; all oils that are essentially liquid at room temperature. Further in the context of this invention, the vegetable oil may also contain oils that are solid or partially solid at room temperature, such as coconut oil, palm kernel oil, babassu oil, palm oil, rhea butter, cocoa butter. Alternatively, fractions of the vegetable oils may be used, or mixtures of the vegetable oils mentioned before, either a mixture as such, or after chemical of enzymatic interesterification. Optionally, a part of the vegetable oil is a blend that is obtained by oil or fat that may be hardened by suitable methods known in the art. A preferred vegetable oil comprises coconut oil and sunflower oil.

In an embodiment, the present plant-based yogurt further comprises an emulsifier, preferably wherein the amount of emulsifier is from 0.02-2% (w/w) of the plant-based yogurt. An emulsifier promotes formation and/or stability of emulsions. Suitable emulsifiers may be the ones known to the skilled person, for example phospholipids (e.g. lecithin and the like), fractionated lecithin, or (partially) hydrolyzed lecithin, or calcium, magnesium, potassium, or sodium salts of fatty acids, mono- and diglycerides (MDG), preferably saturated MDG, and derivatives thereof such as lactic acid esters (“Lactem”) of MDG, acylated tartaric acid esters (“Datem”) of MDG, sorbitan esters of monostearate (Tweens and Spans), sugar esters of fatty acids, polyglycerolesters of fatty acids and the like. Typically, combinations of emulsifiers can be used, such as a combination of MDG and lactic acid esters of MDG. Typically, between 0.1 and 1.5% emulsifier is used. Preferably, the amount of emulsifier is from 0.02-2% (w/w) of the plant-based yogurt, preferably the amount of emulsifier is from 0.1-1.5% (w/w) of the plant-based yogurt such as around 0.5% (w/w) of the plant-based yogurt.

In an embodiment the present plant-based yogurt may comprise a hydrocolloid. Hydrocolloids are a diverse group of long chain polymers characterized by their property of forming viscous dispersions and/or gels when dispersed in water. In the context of the invention, suitable hydrocolloids are galactomannans (guar gum, locust bean gum (LBG) and tara gum), gellan (including low or high-acyl gellan), xanthan, low- and high-methoxy pectins, alginates, carrageenans, gum Arabic, cellulose derivatives such as carboxymethyl cellulose, hydroxypropylmethyl cellulose, methyl cellulose, native and modified starches, citrus fibers and the like. Preferably, the amount of hydrocolloid is from 0.02-1% (w/w) of the plant-based yogurt. More preferably, the amount of hydrocolloid is from 0.1-1% (w/w) of the plant-based yogurt. More preferably, the present composition comprises gellan gum and pectin, more preferably high acyl gellan gum and low methoxy pectin.

In an embodiment, the present plant-based yogurt may comprise minerals, such as sodium chloride or calcium phosphate. Calcium salts, such as for example calcium phosphate or calcium lactate, have the advantage that the nutritional value of dairy products can be mimicked. Certain counterions may impact the protein behaviour in the composition. Preferably, the amount of minerals is within the range of 0.05-1% (w/w) of the composition, such as from 0.1-0.5% (w/w) of the composition.

In an embodiment, the plant-based yogurt is an oil-in-water emulsion. Preferably an oil-in-water emulsion wherein the size of the emulsion droplets has a D50 within the range of 1-50 μm and/or a D90 within the range of 5-70 μm or a D50 within the range of 2-30 μm and/or a D90 within the range of 5-50 μm, preferably a D50 within the range of 5-15 μm and/or a D90 within the range of 10-30 lam. Preferably, the size of the emulsion droplets has a D50 within the range of 2-20 μm, 3-15 μm, 4-12 μm, 5-10 μm. Preferably, the size of the emulsion droplets has a D90 within the range of 10-20 μm, 5-15 μm, 10-25 μm, 5-10 μm. The droplet size—expressed as the D50, D10 or D90, can be measured by particle size distribution assessment methods such as light scattering, and further checked using light microscopy. D50 stands for mass-median-diameter.

In an embodiment, the present plant-based yogurt further comprises micronutrients, sugar, sweetening agents, flavoring agents, flavouring with modifying properties, coloring agents, fruit preparation, calcium salts, starch and/or a cereal. Preferably the present plant-based yogurt comprises a sweetening agent selected from the group consisting of steviol glycosides, maltodextrin, maltitol, mannitol, sorbitol, thaumatine and xylitol.

An example of a flavouring having modifying properties is Modumax© from DSM. Preferably, the present plant-based yogurt comprises Modumax© and a flavour composition chosen from (i) a soy masking composition comprising steviol glycosides having additional glucose units added to the base steviol glycoside molecule via enzymatic glucosylation; (ii) a vanilla flavour composition comprising vanillin; (iii) a cream flavour composition comprising lactones; and (iv) any combinations thereof. Modumax© is preferably a flavour composition comprising glucans, mannans, amino acids, proteins, protein fragments and phospholipids. Preferably comprising (i) 10 to 40% (w/w) glucans;
(ii) 5 to 30% (w/w) mannans;
(iii) 5 to 30% (w/w) free amino acids;
(iv) 10 to 40% (w/w) protein; and
(v) 5 to 25% (w/w) phospholipids.

In an embodiment, the present plant-based yogurt may comprise seeds, nuts and/or cereals. Seeds are selected from sunflower, coconut, chia, flax, tiger nut, quinoa, sesame, hemp, pumpkin and combinations thereof. Nuts can be selected from almonds, cashews, pecans, macadamias, hazelnuts, pistachio, walnuts, and combinations thereof. Cereals are selected from wheat, rye, teff, rice, millet, spelt, barley, oat, sorghum and combinations thereof.

Fruit preparation such as full fruits, pieces, juices, syrups, purees, concentrates etc. can be used. Examples of fruits are cherry, passion, blackberry, blueberry, raspberry, pea, apple, mango, apricot, peach and strawberry.

In a preferred embodiment, the present plant-based yogurt has a reduced astringency compared to a similar plant-based yogurt wherein the total amount of 1 to 10% (w/w) protein of the plant-based yogurt is pea protein or wherein the amount of rapeseed protein is replaced by an equal amount of pea protein.

The term ‘Astringency’ as used in the present context is a sensory attribute which can be explained by the degree in which an astringent, or dry, puckering mouthfeel is present in the mouth after the product has been swallowed (the sensation can also be provoked with red wine, black coffee and the “skin” of a nut).

In a preferred embodiment, the present plant-based yogurt has an improved mouthfeel compared to a similar plant-based yogurt wherein the total amount of 1 to 10% (w/w) protein of the plant-based yogurt is pea protein or wherein the amount of rapeseed protein is replaced by an equal amount of pea protein.

The term “mouthfeel” refers to the physical sensation in the mouth caused by food or drink and is distinct from taste. Mouthfeel is a fundamental sensory attribute which, along with taste and smell, determine the overall perception of a food product. Example of a mouthfeel property are creaminess or smoothness as well as sandiness.

In a preferred embodiment, the present plant-based yogurt has an improved taste compared to a similar plant-based yogurt wherein the total amount of 1 to 10% (w/w) protein of the plant-based yogurt is pea protein or wherein the amount of rapeseed protein is replaced by an equal amount of pea protein.

In a preferred embodiment, the present plant-based yogurt has an improved taste compared to a similar plant-based yogurt wherein the total amount of 1 to 10% (w/w) protein of the plant-based yogurt is rapeseed protein or wherein the amount of pea protein is replaced by an equal amount of rapeseed protein.

The term “taste” refers to the perception produced or stimulated when a substance in the mouth reacts chemically with taste receptor cells located on taste buds in the oral cavity, mostly on the tongue. Examples of a taste property are sweetness, grass taste, astringency or beany taste.

In a preferred embodiment, the present plant-based yogurt has an improved texture compared to a similar plant-based yogurt wherein the total amount of 1 to 10% (w/w) protein of the plant-based yogurt is pea protein or wherein the amount of rapeseed protein is replaced by an equal amount of pea protein.

In a preferred embodiment, the present plant-based yogurt has an improved texture compared to a similar plant-based yogurt wherein the total amount of 1 to 10% (w/w) protein of the plant-based yogurt is rapeseed protein or wherein the amount of pea protein is replaced by an equal amount of rapeseed protein.

The term “texture” refers to visual or mechanical assessment of a food product. Examples of a texture property are gel-like structure with increased water binding, viscosity and smoothness or reduced syneresis. The present inventors found that rapeseed protein and pea protein provide a synergistic effect on the texture of the plant-based yogurt.

In a preferred embodiment, the present plant-based yogurt has a reduced syneresis compared to a similar plant-based yogurt wherein the total amount of 1 to 10% (w/w) protein of the plant-based yogurt is pea protein or wherein the amount of rapeseed protein is replaced by an equal amount of pea protein.

In a preferred embodiment, the present plant-based yogurt has a reduced syneresis compared to a similar plant-based yogurt wherein the total amount of 1 to 10% (w/w) protein of the plant-based yogurt is rapeseed protein or wherein the amount of pea protein is replaced by an equal amount of rapeseed protein.

The term ‘syneresis’ is the extraction of a liquid from the gel. This results in a two-phase product which is not desired by consumers. The present inventors found that the combination of rapeseed protein and pea protein provides a synergistic effect on the stability of a plant-based yogurt and hence a reduction of syneresis.

In a preferred embodiment, the present plant-based yogurt has an increased viscosity compared to a similar plant-based yogurt wherein the total amount of 1 to 10% (w/w) protein of the plant-based yogurt is pea protein or wherein the amount of rapeseed protein is replaced by an equal amount of pea protein.

In a preferred embodiment, the present plant-based yogurt has an increased viscosity compared to a similar plant-based yogurt wherein the total amount of 1 to 10% (w/w) protein of the plant-based yogurt is rapeseed protein or wherein the amount of pea protein is replaced by an equal amount of rapeseed protein.

The term “viscosity” as used herein refers to the state of being thick, and semi-fluid in consistency, due to internal friction. Determination of the viscosity of a fermented milk product is well known to the skilled person. A well accepted method is the use of a Brookfield viscometer. Preferably viscosity is determined using the method as shown in the experimental part disclosed herein.

In an embodiment, the present plant-based yogurt has a viscosity that is higher than a viscosity of similar plant-based yogurt wherein the rapeseed protein is replaced with pea protein or wherein the pea protein is replaced with rapeseed protein. In other words, preferably the present plant-based yogurt, preferably, comprising rapeseed protein and pea protein in a total amount of 1 to 10% (w/w) of the plant-based yogurt, wherein the weight ratio of rapeseed protein to pea protein is from 80:20 to 20:80, has a viscosity that is higher than a similar plant-based yogurt wherein the protein is only pea or only rapeseed protein.

Preferably, the plant-based yogurt, according to embodiments of the invention is a packaged product provided in a sealed or sealable container containing about 50 g, 60 g, 70 g, 75 g, 80 g, 85 g, 90 g, 95 g, 100 g, 105 g, 110 g, 115 g, 120 g, 125 g, 130 g, 135 g, 140 g, 145 g, 150 g, 200 g, 300 g, 320 g or 500 g, 750 g, 1000 g or about 1 oz, 2 oz, 3 oz, 4 oz, 5 oz, 6 oz or 12 oz product by weight.

In other embodiments, the plant-based yogurt is a packaged product provided in a sealed or sealable container containing 50 g to 1000 g, 60 g to 900 g, 70 g to 800 g, 75 g to 700 g, 80 g to 600 g, 85 g to 500 g, 90 g to 500 g, 95 g to 500 g, 100 g to 500 g, 105 g to 500 g, 110 g to 500 g, 115 g to 500 g, 120 g to 500 g, 125 g to 500 g, 130 g to 500 g, 135 g to 500 g, 140 g to 500 g, 145 g to 500 g, 150 g to 500 g, 200 g to 500 g, 300 g to 500 g, 320 g to 500 g or 500 g product by weight. In other embodiments, the plant-based yogurt is provided in a sealed or sealable container containing about 1 oz to 12 oz, 2 oz to 12 oz, 3 oz to 12 oz, 4 oz to 12 oz, 5 oz to 12 oz, 6 oz to 12 oz or 12 oz product by weight.

According to another aspect, the present invention relates to a method for manufacturing a plant-based yogurt as defined above, comprising preparing an emulsion or dispersion comprising rapeseed protein and pea protein in a total amount of 1 to 10% (w/w) of the emulsion, wherein the weight ratio of rapeseed protein to pea protein is from 80:20 to 5:95, preferably is from 60:40 to 5:95, preferably from 80:20 to 20:80, and acidifying the emulsion towards a pH of 3.0 to 6.0, preferably 3.5 or 4 to 5.0, to provide the plant-based yogurt, preferably wherein the step of acidifying the emulsion towards a pH of 3.0 to 6.0, preferably 3.5 to 5.0, is carried out by fermentation of the emulsion by lactic acid bacteria.

The skilled person is aware of common techniques for the preparation of an emulsion. For example, preparing an emulsion comprises mixing the rapeseed protein and pea protein with water, and stirring the mixture was stirred for >10 minutes to fully hydrate the protein to create an aqueous solution, and melting a vegetable fat, optionally adding a liquid oil to the melted fat, followed by dispersing the melted fat or the vegetable oil or the mixture of melted fat and oil into the aqueous solution using a high-shear mixer. High-shear mixers, such as rotor/stator mixers and high-pressure homogenizers, are commonly used in the production of emulsions. The term ‘high shear’ is defined as shear sufficient to result in an oil-in-water emulsion, wherein the size of the emulsion droplets has a D50 within the range of 1-50 μm and/or a D90 within the range of 10-70 μm.

Preferably the emulsion comprising rapeseed protein and pea protein in a total amount of 1 to 10% (w/w) of the emulsion, wherein the emulsion droplets have an droplets size D50 within the range of 1-50 μm and/or a D90 within the range of 5-70 μm or a D50 within the range of 2-30 μm and/or a D90 within the range of 5-50 μm, preferably a D50 within the range of 5-15 μm and/or a D90 within the range of 10-30 μm. Preferably, the size of the emulsion droplets has a D50 within the range of 2-20 μm, 3-15 μm, 4-12 μm, 5-10 μm. Preferably, the size of the emulsion droplets has a D90 within the range of 10-20 μm, 5-15 μm, 10-25 μm, 5-10 μm.

Preferably, the present plant-based yogurt or present emulsion comprises rapeseed protein and pea protein in a total amount of 1 to 9% (w/w), 1.5 to 8% (w/w), 1.6 to 7% (w/w), 2 to 6% (w/w) or 2.5 to 5% (w/w) of the plant-based yogurt or emulsion.

Preferably, the present weight ratio of rapeseed protein to pea protein is from 75:25 to 25:75, preferably from 70:30 to 30:70, preferably from 60:40 to 40:60, preferably from 55:45 to 45:55, preferably 50:50. Alternatively, the present weight ratio of rapeseed protein to pea protein is from 50:50 to 80:20, such as from 60:40 to 75:25.

Alternatively, the present weight ratio of rapeseed protein to pea protein is from 50:50 to 80:20, such as from 60:40 to 75:25.

In an embodiment, the present weight ratio of rapeseed protein to pea protein is from 80:20 to 20:80, preferably is from 60:40 to 20:80.

Preferably, the present weight ratio of rapeseed protein to pea protein is from 80:20 to 5:95, preferably is from 60:40 to 5:95, preferably is from 55:45 to 5:95, preferably is from 50:50 to 10:90, preferably is from 50:50 to 15:85, preferably is from 50:50 to 20:80.

Preferably, the present weight ratio of rapeseed protein to pea protein is from 75:25 to 25:75, preferably from 70:30 to 30:70, preferably from 60:40 to 40:60, preferably from 55:45 to 45:55, preferably 50:50. Alternatively, the present weight ratio of rapeseed protein to pea protein is from 50:50 to 80:20, such as from 60:40 to 75:25.

Preferably the emulsion comprising rapeseed protein and pea protein in a total amount of 1 to 10% (w/w) of the emulsion is an oil-in-water emulsion, preferably wherein the size of the emulsion droplets has a D50 within the range of 1-50 μm and/or a D90 within the range of 5-70 μm or a D50 within the range of 2-30 μm and/or a D90 within the range of 5-50 μm, preferably a D50 within the range of 5-15 μm and/or a D90 within the range of 10-30 μm. Preferably, the size of the emulsion droplets has a D50 within the range of 2-20 μm, 3-15 μm, 4-12 μm, 5-10 μm. Preferably, the size of the emulsion droplets has a D90 within the range of 10-20 μm, 5-15 μm, 10-25 μm, 5-10 μm. The droplet size—expressed as the D50, D10 or D90, can be measured by particle size distribution assessment methods such as light scattering, and further checked using light microscopy.

Preferably the present step of comprising preparing an emulsion or dispersion comprising rapeseed protein and pea protein in a total amount of 1 to 10% (w/w) of the emulsion comprises adding hydrocolloids as defined herein. Preferably the hydrocolloids are first hydrated followed by adding the hydrocolloids mix to the protein emulsion. Preferably the pH of the hydrocolloid dispersion is modified by acids or base before it is added to the protein dispersion, to match the pH of the protein dispersion.

In an embodiment, the present step of acidifying the emulsion towards a pH of 3.0 to 6.0, preferably 3.5 to 5.0, is carried out by fermentation of the emulsion by lactic acid bacteria. Preferably the lactic acid bacteria as defined above. Preferably the fermentation step is carried out until a pH is reached with the range of 4.2 to 4.9, such as of 4.3 to 4.8 or 4.4 to 4.7. Preferably, the fermentation step is carried out until a plant-based yogurt is provided comprising at least 10⁶, preferably at least 10⁷, preferably at least 10⁸ CFU or at least 10⁹ CFU (colony-forming unit) per gram of the plant-based yogurt.

Preferably, the present method comprises a pasteurization step. Preferably pasteurization of the emulsion. Pasteurization may be carried out batch-wise with a cooking mixer, such as a Thermomixer, Kenwood induction machine, Stephan machine, or alternative comparable equipment, or (semi-) continuously by using for instance a tubular heat exchanger or a plate heat exchanger, and similar processes on industrial scale. To ensure optimum starch gelatinization, the product should be treated at a temperature of 70° C. to 120° C. for 1 minute to 15 minutes, such as 80° C. to 110° C. for 1 minute to 15 minutes. On industrial scale this may be carried out with direct or indirect tubular heat exchange systems, or other processes known in the art. This pasteurization might result in a rapeseed protein isolate having an enthalpy of denaturation in the hydrated state (DH value) of around 0, for example of from 0 to 1 J/g or of 0±0.5 J/g, as defined above.

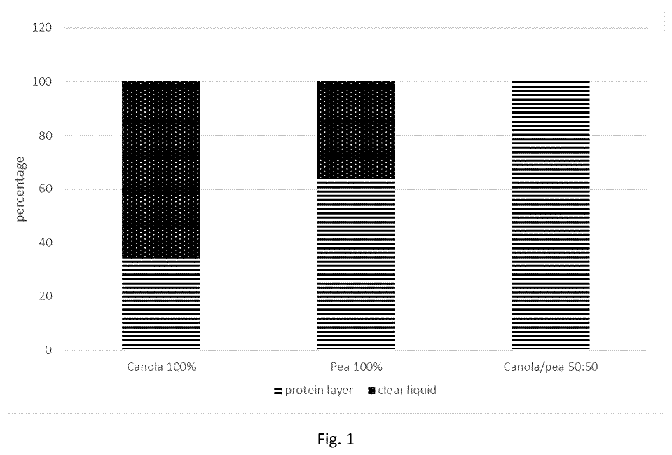

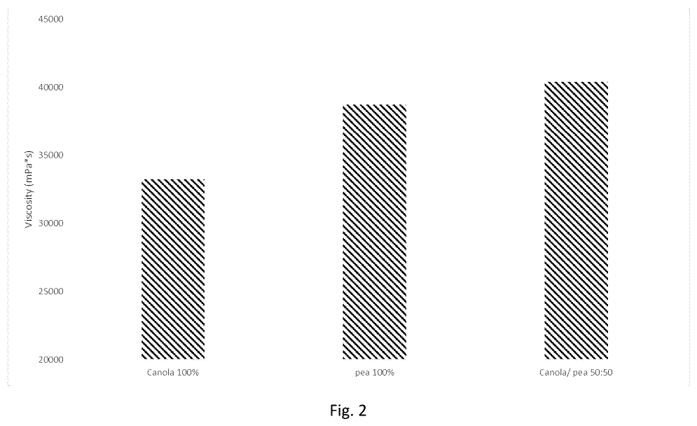

According to another aspect, the present invention relates to the use of rapeseed protein (isolate) for reducing the astringency in a plant-based yogurt, preferably in a plant-based yogurt comprising pea protein. Preferably a rapeseed protein (isolate) as defined above. Preferably, a plant-based yogurt as defined above. The invention is further illustrated in the examples, making reference to FIG. 1 showing dispersion stability and FIG. 2 showing viscosity.

### EXAMPLES

Materials

Rapeseed protein isolate was prepared from cold-pressed rapeseed oil seed meal as described in WO 2018/007492; the protein content was 90% (w/w). The resultant rapeseed protein isolate comprised in the range from 40 to 65% (w/w) of cruciferins and 35 to 60% (w/w) napins, and had a solubility of at least 88% when measured over a pH range from 3 to 10 at a temperature of 23±2° C.

Gellan gum was from DSM Hydrocolloids (Tongxiang, China), LM-pectin (APC310FB) from DSM Hydrocolloids (Tongxiang, China), starch was from Tate and Lyle, pea protein isolate was Pisane C9 from Cosucra (86% protein) or DMPP80plus from JianYuan (>80% protein). Sodium chloride was from Merck, tricalcium phosphate tribasic from Sigma Aldrich, sunflower oil was from Albert Heijn (The Netherlands). Sunflower lecithin was (Solec Z or Solec M) from Unimills (Zwijndrecht, The Netherlands). Unless stated otherwise, all other chemicals were from Merck. The high shear mixer was from Silverson, Thermomixer from Vorwerk (Switzerland), the homogenizer (M110D) from Microfluidics.

The yogurt starter culture Delvo©Fresh YS-141 from DSM Food Specialties (The Netherlands) comprises Streptococcus thermophilus and Lactobacillus delbrueckii ssp. Bulgaricus.

Test Methods

Measurement of pH pH measurements were carried out at 20±2° C., unless otherwise mentioned, using a Radiometer model PHM220 pH meter equipped with a PHC3085-8 Calomel Combined pH electrode (D=5 MM).

Brookfield

Viscosity measurements were performed using a Brookfield DV-II+Pro+ Viscometer, which allows viscosity measurement on an undisturbed product (directly in the pot). The Brookfield Viscometer determines viscosity by measuring the force required to turn the spindle into the product at a given rate. The Helipath system with a T-D spindle was used as it is designed for non-flowing thixotropic material (gels, cream). It slowly lowers or raises a rotating T-bar spindle into the sample so that not always the same region of the sample is sheared (helical path). Thus, the viscometer measures constantly the viscosity in fresh material, and is thus thought to be the most suitable for measuring stirred yogurt viscosity. A speed of 30 rpm was used for 31 measuring points, at an interval of 3 sec. The average of the values between 60 and 90 seconds were reported.

### Example 1

Dispersion Stability

Protein dispersions of 1000 ml were prepared at room temperature with different rapeseed:pea ratios (respectively 100:0; 50:50 and 0:100) and mixed with high shear mixer from Silverson at 8000 rpm for 3 minutes. Two layers were formed, and the stability of the dispersions was determined by measuring both layers after 10 minutes. The results are shown in FIG. 1. FIG. 1 shows that the combination of pea protein and canola protein increases the stability above the stability of pea or rapeseed protein alone.

### Example 2

Preparation of Plant-Based Yogurt with 3.2% Protein Plant-based yogurts are prepared using the protein emulsions 1 to 3 as shown below in table 1.

TABLE 1

| Ingredient | Emulsion 1 | | Emulsion 2 | | Emulsion 3 | |
|---|---|---|---|---|---|---|
| Palm kernel fat | 4.5 | w/w % | 4.5 | w/w % | 4.5 | w/w % |
| Sunflower oil | 1.6 | w/w % | 1.6 | w/w % | 1.6 | w/w % |
| Lecithin | 0.08 | w/w % | 0.08 | w/w % | 0.08 | w/w % |
| Rapeseed protein | 3.2 | w/w % | — | | 1.6 | w/w % |
| isolate | | | | | | |
| Pea protein isolate | — | | 3.2 | w/w % | 1.6 | w/w % |
| Starch | 4.5 | w/w % | 4.5 | w/w % | 4.5 | w/w % |
| Sucrose | 2.25 | w/w % | 2.25 | w/w % | 2.25 | w/w % |
| NaCl | 0.10 | w/w % | 0.10 | w/w % | 0.10 | w/w % |
| Calcium phosphate | 0.3 | w/w % | 0.3 | w/w % | 0.3 | w/w % |
| HA-gellan | 0.036 | w/w % | 0.036 | w/w % | 0.036 | w/w % |
| LM-Pectin | 0.43 | w/w % | 0.43 | w/w % | 0.43 | w/w % |
| Water | 83.0 | w/w % | 83.0 | w/w % | 83.0 | w/w % |

Hydrocolloid Solution:

LM-pectin (4.3 g) and gellan (0.36 g) were weighed into a beaker and added to 415 g tap water. The solution was stirred for at least 30 minutes at 20±2° C. to reach the optimum hydration. Subsequently, the glass beaker was placed in a water bath of 87±2° C. for 30 min while the mixture was stirred. After cooling to 40±2° C. the mixture was used in the preparation of the rapeseed protein emulsion below.

Palm Kernel Fat

Palm kernel fat (45 g) was weighed into a beaker and placed in water bath of 87±2° C. for 30 min. After cooling to 40±2° C. sunflower oil (16 ml) was added and the mixture was used in the preparation of the protein emulsion below.

Protein Emulsion:

Rapeseed protein isolate, a pea protein isolate (Pisane) (32 g together), sucrose (22.5 g), starch (45 g), calcium phosphate (3 g), NaCl (1 g) were weighed into a beaker and added to 415 g tap water. The solution was stirred with a stirring bar for at least 30 minutes at 20±2° C. to reach the optimum hydration of the protein. Subsequently, the hydrocolloid and fat solutions were added. This was emulsified by vigorously mixing for 3 minutes 8000 rpm by using a high shear mixer (Silverson). After mixing, the pH was adjusted with aqueous hydrochloric acid (0.5 M) or aqueous sodium hydroxide (0.5 M) to a pH of around 6.6. Depending on the ratio of the rapeseed protein isolate to pea protein isolate (here exemplified for the 50:50 ratio), the resulting emulsion contained: 1.6% (w/w) of rapeseed protein isolate, 1.6% of pea protein isolate, 1.6% palm kernel fat, 1.6% sunflower oil, 4.5% starch, 2.25% sucrose, 0.3% Calcium, 0.1% NaCl, 0.43% LM-pectin and 0.036% HA gellan. Finally, the emulsion was heated in a Thermomixer during 5 minutes at 95° C.

Preparation of Yogurt:

300 ml of the protein emulsion was fermented with yogurt starter culture Delvo©Fresh YS-141 by adding 2 U/10001. Incubation was done at 38° C. in a water bath until a pH of 4.6 was reached. The plant-based yogurt was stored at 4-6° C. for later use. Upon visual inspection the pea/canola yogurt showed a white yogurt like appearance.

### Example 3

Texture Analyses of Plant-Based Yogurt

Texture analysis with the Brookfield viscometer of the plant-based yogurts of example 2 was done after 3 days storage at 4-6° C. FIG. 2 shows that a mixture of pea protein and canola protein generally has increased viscosity.

### Example 4

Sensory Assessment of a Plant-Based Yogurt

The plant-based yogurts prepared in example 2 was assessed for the sensory attribute astringency. The yogurts were tested on texture, astringency and an overall yogurt perception taste was given for the for comparability with real dairy yogurt, using the following categories.

| | | |
|---|---|---|
| Texture | + not like yogurt | +++ exactly like real |
| | | dairy yogurt |
| Astringency | + low and | +++ high |
| Overall yogurt | + the least tasty | +++ most dairy yogurt |
| perception taste | | like taste |

The table below shows the total number of ‘+’ rated by 4 panelists. So the maxim score would be 4 times ‘+++’, i.e. 12, and the lowest score is 4 times ‘+’, i.e. 4. The results are shown in table 2 below.

TABLE 2

| Emulsion | | | | yogurt |
|---|---|---|---|---|
| recipe | protein | texture | astringency | perception |
| 1 | Rapeseed protein | 9 | 9 | 5 |
| 2 | Pea protein | 9 | 7 | 4 |
| 3 | Rapeseed & pea protein | 10 | 5 | 8 |

The results show that the astringency of pea protein can be reduced by addition of rapeseed protein. For the yogurt taste perception, the addition of rapeseed protein to pea protein improves the yogurt taste.

### Example 5

Plant-Based Yogurt with Different Rapeseed Protein:Pea Protein Ratios with 6% Total Protein

Plant-based yogurts with a higher protein and lower starch content than the recipe of example 3 were prepared by using the ingredients listed in table 3 below, wherein amounts are expressed as weight %. Samples were prepared with a total weight of 3000 gram. A protein emulsion was prepared by blending in 1.471 liter water the rapeseed and pea protein isolate, starch, sucrose, calcium phosphate and salt, and mixed under high shear for 5 minutes at room temperature and left to hydrate for 25 minutes at room temperature. A hydrocolloids mix was prepared by blending the pectin with 0.980 liter water of 49° C. followed by mixing under high shear for 5 minutes at room temperature and left to hydrate for 30 minutes at room temperature. Thereafter the pH of the hydrocolloids phase was set to 6.8 using 1M NaOH. An oil mix was prepared by heating the coconut oil to 43° C., and blending with the sunflower oil on a stirring plate until homogenous. Subsequently, the protein emulsion, the hydrocolloid mix and the oil mix were mixed under high shear (Silverson high shear mixer) for 5 minutes at room temperature. The samples were heated with a UHT processing line (HT122, OMVE, The Netherlands) to a temperature of 90° C. for 5 minutes. Subsequently the base was homogenized at 170+30 bar in a OMVE HP202 unit. The homogenized base was inoculated with the yogurt culture and fermented at 42° C. until pH 4.6 was reached. The yogurts were thereafter stored at 4° C. until further use. Six different yogurts were made, with varying ratios of rapeseed protein isolate and pea protein isolate, as is indicated in table 4.

TABLE 3

| Ingredient | Amount |
|---|---|
| Rapeseed protein isolate + Pea protein isolate | 6.0% |
| (DMPP80plus, JianYuan) | |
| LM pectin (DSM, APC300FB) | 0.3% |
| Tapioca starch (1 claria bliss 570:1 everlast | 2.0% |
| 565, Tate & Lyle) | |
| Sucrose (AH) | 6.0% |
| Table salt (AH) | 0.10% |
| Calcium phosphate (Sigma- Aldrich) | 0.34% |
| Coconut oil (AH) | 2.0% |
| Sunflower oil (AH) | 1.5% |
| Yogurt culture (Delvo ©Fresh YS-141, DSM) | 0.035% |
| Water | Up to 100% |

Results

The plant-based yogurts were assessed by a group of 10 tasters on mouthfeel, texture and astringent taste. The yogurts were tasted and assessed using the following rating:
Astringent taste: low (1) versus high (5).
Off flavour: low (1) versus high (5).
Texture: thin (1) versus thick (5)
Mouthfeel: smooth (1) versus sandy (5)

The results are shown in table 4 below and are an average of 10 tasters.

TABLE 4

| Yogurt no. | 1 | 2 | 3 | 4 | 5 | 6 |
|---|---|---|---|---|---|---|
| Ratio rapeseed | 0:100 | 10:90 | 25:75 | 50:50 | 75:25 | 100:0 |
| protein:pea protein | | | | | | |
| Astringent taste | 3.4 | 2.7 | 2.9 | 3.1 | 3.3 | 4.6 |
| Off-flavour | 3.4 | 2.0 | 2.6 | 2.8 | 3.4 | 4.3 |
| Texture | 5.0 | 3.6 | 2.7 | 1.7 | 1.4 | 1.0 |
| Mouthfeel | 3.0 | 1.4 | 2.0 | 2.6 | 2.5 | 2.3 |

The results shown in table 4 show that adding rapeseed protein to pea protein provides lower astringency, less off flavour, and lower sandiness (mouthfeel). Moreover, at high protein concentration (6%) the combination of pea protein and rapeseed protein reduces the thickness of 100% pea protein and leads to an improved (more dairy yogurt like) texture.

1. A plant-based yogurt comprising rapeseed protein and pea protein in a total amount of 1 to 10% (w/w) of the plant-based yogurt, wherein the weight ratio of rapeseed protein to pea protein is from 80:20 to 5:95, optionally is from 60:40 to 5:95.

2. A plant-based yogurt according to claim 1, wherein the weight ratio of rapeseed protein to pea protein is from 80:20 to 20:80, optionally is from 60:40 to 20:80.

3. A plant-based yogurt according to claim 1, having a pH within the range of 3.0 to 6.0, optionally 3.5 to 5.0, optionally 3.8 to 4.6.

4. A plant-based yogurt according to claim 1, further comprising lactic acid bacteria.

5. A plant-based yogurt according to claim 1, wherein the plant-based yogurt is set yogurt, stirred yogurt, drinking yogurt, Petit Suisse, Greek-style yogurt, Skyr-style, heat treated yogurt or a yogurt-like product.

6. A plant-based yogurt according to claim 1, wherein said rapeseed protein is rapeseed protein isolate comprising cruciferins and/or napins, comprising optionally 10 to 95% (w/w) cruciferins and/or 5% to 90% (w/w) napins, comprising optionally 40-65 (w/w) cruciferins and 35-60% (w/w) napins, comprising optionally 60 to 80% (w/w) cruciferins and 20 to 40% (w/w) napins, comprising optionally 0 to 10% (w/w) cruciferins and 90 to 100% (w/w) napins.

7. A plant-based yogurt according to claim 1, wherein said rapeseed protein comprises 40 to 65 wt. % cruciferins and 35 to 60 wt. % napins.

8. A plant-based yogurt according to claim 1, wherein said rapeseed protein comprises 60 to 80 wt. % cruciferins and 20 to 40 wt. % napins.

9. A plant-based yogurt according to claim 1, wherein said rapeseed protein comprises 0 to 10 wt. % cruciferins and 90 to 100 wt. % napins.

10. A plant-based yogurt according to claim 1, further comprising a vegetable oil or fat and optionally an emulsifier.

11. A plant-based yogurt according to claim 1, further comprising a hydrocolloid in an amount of 0.02 to 2% (w/w) of the plant-based yogurt.

12. A plant-based yogurt according to claim 1, further comprising micronutrients, sugar, sweetening agents, flavoring agents, coloring agents, fruit preparation, calcium salts, starch and/or a cereal.

13. A plant-based yogurt according to claim 1, having a reduced astringency compared to a similar plant-based yogurt wherein the total amount of 1 to 10% (w/w) protein of the plant-based yogurt is pea protein.

14. A method for manufacturing a plant-based yogurt as defined in claim 1, comprising preparing an emulsion comprising rapeseed protein and pea protein in a total amount of 1 to 10% (w/w) of the emulsion, wherein the weight ratio of rapeseed protein to pea protein is from 80:20 to 5:95, optionally is from 60:40 to 5:95, and acidifying the emulsion towards a pH of 3.0 to 6.0, optionally 4.0 to 5.0 to provide the plant-based yogurt, optionally wherein the step of acidifying the emulsion to a pH of 3.0 to 6.0, optionally 4.0 to 5.0, is carried out by fermentation of the emulsion by lactic acid bacteria.

15. A product comprising rapeseed protein for reducing the astringency in plant-based yogurt.
